(19) United States
(12) Patent Application Publication
(10) Pub. No.: US 2019/0240643 A1
(43) Pub. Date: Aug. 8, 2019

(54) CATALYST COMPRISING BIMETALLIC PLATINUM GROUP METAL NANOPARTICLES

(71) Applicant: BASF Corporation, Florham Park, NJ (US)

(72) Inventors: Andrey Karpov, Speyer (DE); Benjamin Foulon, Iselin, NJ (US); Chunxin JI, Hillsborough, NJ (US); Knut Wassermann, Princeton, NJ (US); Michel Deeba, East Brunswick, NJ (US); Yipeng Sun, West Windsor, NJ (US)

(73) Assignee: BASF Corporation, Florham Park, NJ (US)

(21) Appl. No.: 16/320,572

(22) PCT Filed: Jun. 15, 2017
(86) PCT No.: PCT/US2017/037627

§ 371 Date: Jan. 25, 2019

Related U.S. Application Data
(60) Provisional application No. 62/367,794, filed on Jul. 28, 2016.

(51) Int. Cl. B01J 23/44; B01J 23/46; B01J 35/02; B01J 37/02; B01J 37/16; B01J 35/00; B01J 35/04; F01N 3/10; F01N 3/20

(52) U.S. Cl. CPC B01J 23/44; B01J 23/464; B01J 35/023; B01J 37/0244; B01J 37/0248; B01J 21/04; B01J 35/0013; B01J 35/04; F01N 3/101; F01N 3/20; F01N 2510/0684; B01J 37/16

(57) ABSTRACT

The present disclosure provides a three-way conversion (TWC) catalyst composition, and a catalyst article comprising such a catalyst composition suitable for at least partial conversion of gaseous hydrocarbons (HCs), carbon monoxide (CO), and nitrogen oxides (NOₓ). Generally, the catalyst article includes a catalyst substrate having a plurality of channels adapted for gas flow, each channel having a wall surface and a catalytic coating on the surfaces or inside the pores of the wall. The catalytic coating generally includes a first washcoat with a platinum group metal (PGM) component and a first refractory metal oxide support and a second washcoat having a plurality of palladium-rhodium nanoparticles and a second refractory metal oxide support.

### TECHNICAL FIELD

The present invention is directed to catalyst articles for purifying exhaust gas emissions and methods of making and using the same. More particularly, the invention pertains to catalyst articles containing palladium-rhodium nanoparticles to achieve efficient conversion of nitrogen oxides.

### BACKGROUND OF THE INVENTION

Current automotive catalysts for exhaust treatment of gasoline-powered vehicles include three way catalysts (TWCs) or four way catalysts (FWCs™). Such catalysts utilize palladium (Pd) and rhodium (Rh) as active species for conversion of hydrocarbons (HCs), carbon monoxide (CO), and nitrogen oxides (NOₓ) into harmless carbon dioxide (CO₂), nitrogen (N₂) and water (H₂O).

Pd by itself is an active component for oxidation of HCs and CO into CO₂, while Rh by itself is an efficient component for conversion of NOₓ into N₂. Pd is currently the cheapest of the platinum group metals (PGMs) and provides very good thermal durability although exhibiting increased sensitivity to catalytic poisons, e.g., sulfur. Rh is currently the most expensive PGM, but exhibits good resistance to sulfur-containing catalytic poisons. Accordingly, both Pd and Rh are typically required for the simultaneous conversion of all three pollutants (HC, CO, and NOₓ) into harmless products.

One of the main challenges in TWC design is how to most effectively use Rh. The thermal durability of Rh is not as good as that of Pd and Rh often undergoes a strong deactivation interaction with alumina at temperatures of about 600° C. and above. Various Rh deactivation mechanisms have been suggested including rhodium aluminate formation, encapsulation of the Rh by alumina. For example, it has been observed that when Rh is utilized in the presence of Pd under oxidizing conditions at high temperatures, Pd—Rh alloys can form. Excessive Pd can form PdO covering the surface of the Pd—Rh alloys, which can strongly suppress NOₓ conversion. To avoid formations of undesirable Pd—Rh alloys, current Pd/Rh TWC formulations often use Pd and Rh on separate support phases.

As such, there is a continuing need in the art to provide TWC catalytic materials that provide excellent catalytic activity, thermal stability, and efficient use of a Rh component and a Pd component.

### SUMMARY OF THE INVENTION

Provided are catalyst articles comprising at least two washcoat layers, wherein a first layer contains thermally stable Rh-containing multimetallic particles (e.g., Pd—Rh nanoparticles) and a second washcoat layer contains a platinum group metal (PGM) component. The at least two washcoat layers can be in various positions with respect to one another on a substrate (e.g., layered and/or zoned). Rh-containing multimetallic nanoparticles are dispersed onto a refractory metal oxide support (e.g., alumina) during formation of Rh-containing catalyst compositions in such a way that nanoparticles remain dispersed and not agglomerated. The Rh-containing nanoparticle-containing catalyst compositions are stable under high aging temperatures, providing increased thermal stability to the catalyst articles, which can maintain their catalytic activity. Excellent conversion of hydrocarbons, carbon monoxide, and nitrogen oxides is achieved using such catalyst articles.

One aspect of the invention is directed to a catalyst article for abatement of exhaust gas emissions from an internal combustion engine including a catalyst substrate having a plurality of channels adapted for gas flow, each channel having a wall surface and a catalytic coating the surfaces or inside the pores of the wall, wherein the catalytic coating comprises a first washcoat comprising a platinum group metal (PGM) component and a first refractory metal oxide support and a second washcoat comprising a plurality of palladium-rhodium nanoparticles and a second refractory metal oxide support. In some embodiments, the second washcoat is present as a top layer of the catalytic coating. In some embodiments, the first washcoat is disposed directly on the catalyst substrate and the second washcoat is disposed on top of the first washcoat. In some embodiments, the first washcoat and the second washcoat are present in a zoned configuration. As such, the catalytic coating described herein can comprise one (zoned) layer, two layers, or more layers (e.g., three layers), wherein one or more layers can be optionally zoned.

In some embodiments, the palladium-rhodium nanoparticles have an average primary particle size of about 1 to about 20 nm. In some embodiments, the palladium-rhodium nanoparticles have an average primary particle size of about 5 to about 10 nm.

In some embodiments, the palladium-rhodium nanoparticles have a weight ratio of Pd:Rh of about 1:10 to about 10:1. In some embodiments, the palladium-rhodium nanoparticles have a weight ratio of Pd:Rh of about 1:1 to about 3:1.

In some embodiments, the second refractory metal oxide support is alumina. In some embodiments, the first refractory metal oxide support is an oxygen storage component. In some embodiments, the PGM component is palladium.

In some embodiments, the PGM component comprises palladium, the first refractory metal oxide support is a ceria-zirconia composite, and the second refractory metal oxide support is alumina.

In some embodiments, the first washcoat further comprises one or more additional components selected from the group consisting of a promoter, stabilizer, and combinations thereof.

Another aspect of the invention is directed to a method for reducing one or more of CO, HC, and NOₓ levels in an exhaust gas emission stream from an internal combustion engine, comprising contacting the exhaust gas emission stream with a catalyst article according to the invention.

Another aspect of the invention is directed to an exhaust gas treatment system for reducing one or more of CO, HC, and NOₓ levels in an exhaust gas emission stream from the internal combustion engine, comprising the catalyst article of the invention, disposed downstream from the internal combustion engine. In some embodiments, the internal combustion engine is a gasoline engine.

Another aspect of the invention is directed to a method of making a catalyst article comprising:

(a) coating of at least a portion of a substrate carrier with a first washcoat comprising a PGM component and a first refractory metal oxide support to give a coated single-layer substrate carrier; and
(b) coating at least a portion of the single-layer substrate carrier with a second washcoat comprising a plurality of palladium-rhodium nanoparticles and a second refractory metal oxide support to give a catalyst article.

In some embodiments, the method further comprises providing the first washcoat, including the steps of:

forming an aqueous solution of a PGM salt;

contacting the aqueous solution with the first refractory metal oxide support to form a PGM-containing first refractory metal oxide support; and

mixing the PGM-containing first refractory metal oxide support with a solvent to form the first washcoat in the form of a slurry.

In some embodiments, the method further comprises providing the second washcoat, including the steps of:

forming an aqueous solution of a salt of rhodium and a salt of palladium, a reducing agent, and a surfactant;

mixing and heating the aqueous solution, thereby reducing at least a portion of the rhodium and palladium to a zero valance form by action of the reducing agent in the presence of the surfactant, forming an aqueous dispersion of palladium-rhodium nanoparticles;

contacting the aqueous dispersion of palladium-rhodium nanoparticles with a refractory support, forming a catalytic material;

drying the catalytic material; and

mixing the dried catalytic material with solvent to form the second washcoat in the form of a slurry.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention.

FIG. 1 is a perspective view of a honeycomb-type substrate carrier which may comprise a catalyst article in accordance with the present invention;

FIG. 2 is a partial cross-sectional view enlarged relative to FIG. 1 and taken along a plane parallel to the end faces of the substrate carrier of FIG. 1, which shows an enlarged view of a plurality of the gas flow passages shown in FIG. 1, in an embodiment wherein the substrate is a monolithic flow-through substrate;

FIG. 3 is a cutaway view of a section enlarged relative to FIG. 1, wherein the honeycomb-type substrate carrier in FIG. 1 is a monolithic wall flow filter substrate;

FIG. 4 shows a cross-sectional view of a layered catalyst of the present invention;

FIG. 5 shows a cross-sectional view of a zoned catalyst of the present invention;

FIG. 6 provides a TEM image of prepared purified Pd—Rh nanoparticles with a scale of 50 nm;

FIG. 7 shows a cross-sectional view of a zoned and layered catalyst of the present invention;

FIG. 8 shows a cross-sectional view of another zoned and layered catalyst of the present invention;

FIG. 9 shows the accumulated tail pipe HC emissions of the reference catalyst sample, comparison catalyst sample 1, and comparison catalyst sample 2 under the NEDC drive cycle;

FIG. 10 shows the accumulated tail pipe CO emissions of the reference catalyst sample, comparison catalyst sample 1, and comparison catalyst sample 2 under the NEDC drive cycle; and

FIG. 11 shows the accumulated tail pipe NOₓ emissions of the reference catalyst sample, comparison catalyst sample 1, and comparison catalyst sample 2 under the NEDC drive cycle.

### DETAILED DESCRIPTION OF THE INVENTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise.

The current invention describes catalyst composition having Rh-containing multimetallic nanoparticles. These Rh-containing multimetallic nanoparticles are dispersed on a refractory metal oxide support (e.g., alumina) in such a way as to minimize negative interactions between Rh and the support (e.g., between Rh and Al₂O₃). In some embodiments, the Rh-containing multimetallic nanoparticles remain dispersed and not agglomerated when such metal-modified refractory metal oxide supports are prepared.

The following definitions are used herein.

Reference to “inside aggregated particles of the support”, which is only relevant to certain specific embodiments, means inside the pores or voids internal to support materials (comprising aggregated particles) where a nanoparticle can reside and be substantially surrounded by support material. Inside aggregated particles of the support is in contrast to being located on an external surface of a support, where a particle can only be adjacent to the support material and not “inside” or “within” that support.

“Thermally affixed”, which is only relevant to certain specific embodiments, means that a PGM and support combination is heated, e.g., at least greater than about 250° C., such that the PGMs are partially or completely converted to their oxide forms, resulting in the removal of any organic material present due to the use of precursor compounds, water, and processing aids such as surfactants, and providing a powdered product. Thermally affixed is different from chemically fixed, where the pH or some other parameter of a dispersion of a PGM salt with support is changed to render the PGM component insoluble in the dispersion.

As used herein, the terms “upstream” and “downstream” refer to relative directions according to the flow of an engine exhaust gas stream from an engine towards a tailpipe, with the engine in an upstream location and the tailpipe and any pollution abatement articles such as catalysts and filters being downstream from the engine.

As used herein, the term “stream” broadly refers to any combination of flowing gas that may contain solid or liquid particulate matter. The term “gaseous stream” or “exhaust gas stream” means a stream of gaseous constituents, such as the exhaust of an internal combustion engine, which may contain entrained non-gaseous components such as liquid droplets, solid particulates, and the like. The exhaust gas stream of an internal combustion engine typically further comprises combustion products, products of incomplete combustion, oxides of nitrogen, oxides of sulfur, combustible and/or carbonaceous particulate matter (soot), and un-reacted oxygen and nitrogen.

As used herein, the term “catalytic article” refers to an element that is used to promote a desired reaction. For example, a catalytic article may comprise a washcoat containing catalytic compositions on a substrate.

The term “abatement” means a decrease in the amount, caused by any means.

As used herein, “impregnated” or “impregnation” refers to permeation of the catalytic material into the porous structure of the support material.

As used herein, the term “primary particles” refers to individual particles of material.

As used herein, the term “average particle size” refers to a characteristic of particles that indicates, on average, the diameter of the particles. In some embodiments, such an average particle size can be measured by transmission electron microscopy (TEM).

As used herein, the term “washcoat” is a thin, adherent coating of a catalytic or other material applied to a refractory substrate, such as a honeycomb flow-through monolith substrate or a filter substrate, which is sufficiently porous to permit the passage therethrough of the gas stream being treated. A “washcoat layer,” therefore, is defined as a coating that is comprised of support particles and can be applied either outside of the wall of the substrate (e.g. flow-through monolith substrate) or inside the pores of the wall of the substrate (e.g. filters). A “catalyzed washcoat layer” is a coating comprised of support particles impregnated with catalytic components.

### Catalyst Composition(s)

The palladium-rhodium (Pd—Rh) nanoparticle-containing catalyst composition includes Pd—Rh nanoparticles dispersed on a refractory metal oxide support. In some embodiments, the weight ratio of Pd:Rh ranges from about 1:10 to about 10:1, preferably 1:1 to about 3:1. The concentrations of Rh and/or Pd can vary, but will typically be from about 0.1 wt. % to about 2 wt. % relative to the weight of the Pd—Rh nanoparticle containing refractory oxide support.

In some embodiments, the palladium-rhodium (Pd—Rh) nanoparticle-containing catalyst composition is substantially free of rhodium, other than the rhodium within the nanoparticles. As used herein, the term “substantially free of rhodium” means that there is no additional rhodium intentionally added to the Pd—Rh nanoparticle containing catalyst composition, and, in some embodiments there is less than about 0.01 wt. % of any additional rhodium by weight present in the catalyst composition. In some embodiments, “substantially free of Rh” includes “free of Rh.” It will be appreciated by one of skill in the art, however that during loading/coating, trace amounts of Rh metal may migrate from one washcoat component to another, such that trace amounts of Rh metal can be present in the Pd—Rh nanoparticle containing washcoat. In some embodiments, additional rhodium (free rhodium) is intentionally added to the washcoat comprising Pd—Rh nanoparticles. In some embodiments, at least about 10 wt. % of Rh in the Pd—Rh nanoparticle containing washcoat is in the form of the Pd—Rh nanoparticles. In certain embodiments, at least 10 wt. %, or at least 20 wt. %, or at least 50 wt. % of Rh in the layer is in the form of Pd—Rh nanoparticles (e.g., about 10 wt. % to about 70 wt. % of Rh in the layer is in the form of Pd—Rh nanoparticles).

In some embodiments, average primary particle size of Pd—Rh nanoparticles is less than about 1 micron, preferably less than about 100 nm, more preferably in the range of about 1 nm to about 20 nm, about 2 to about 18 nm, about 3 to about 15 nm, or about 5 to about 10 nm.

The PGM component-containing catalyst composition includes a PGM component dispersed onto a refractory metal oxide support. As used herein, “platinum group metal” or “PGM” refers to platinum group metals or oxides thereof, including platinum (Pt), palladium (Pd), ruthenium (Ru), rhodium (Rh), iridium (Ir), and mixtures thereof. In some embodiments, PGM component-containing washcoat composition is substantially free of rhodium (Rh). As used herein, the term “substantially free of rhodium” means that there is no additional rhodium intentionally added to the PGM component-containing washcoat composition, and that there is less than about 0.01 wt. % of any additional rhodium by weight present in the washcoat composition. In some embodiments, Rh is present in the PGM component-containing washcoat composition in an amount greater than 0.01 wt. % based on the weight of the metal dispersed refractory metal oxide support. In one or more embodiments, the PGM component comprises palladium. In some embodiments, the refractory oxide support comprises an oxygen storage component. The concentration of the PGM component (e.g., Pd) can vary, but will typically be from about 0.1 wt. % to about 20 wt. % relative to the weight of the metal dispersed refractory metal oxide support.

As used herein, “refractory metal oxide” refers to a metal-containing oxide support exhibiting chemical and physical stability at high temperatures, such as the temperatures associated with gasoline and diesel engine exhaust. Exemplary refractory metal oxides include alumina, silica, zirconia, titania, ceria, and physical mixtures or chemical combinations thereof, including atomically-doped combinations. In some embodiments, “refractory metal oxide” is modified with a metal oxide(s) of alkali, semimetal, and/or transition metal, e.g., La, Mg, Ba, Sr, Zr, Ti, Si, Ce, Mn, Nd, Pr, Sm, Nb, W, Mo, Fe, or combinations thereof. In some embodiments, the amount of metal oxide(s) used to modify the “refractory metal oxide” can range from about 0.5% to about 50% by weight based on the amount of “refractory metal oxide”.

Exemplary combinations of metal oxides include alumina-zirconia, ceria-zirconia, alumina-ceria-zirconia, lanthana-alumina, lanthana-zirconia, lanthana-zirconia-alumina, baria-alumina, baria lanthana-alumina, baria lanthana-neodymia alumina, and alumina-ceria.

In some embodiments, high surface area refractory metal oxide supports are used, such as alumina support materials, also referred to as “gamma alumina” or “activated alumina,” typically exhibit a BET surface area in excess of 60 m²/g, often up to about 200 m²/g or higher. “BET surface area” has its usual meaning of referring to the Brunauer, Emmett, Teller method for determining surface area by N₂ adsorption. In one or more embodiments the BET surface area ranges from about 100 to about 150 m²/g. Useful commercial alumina include high surface area alumina, such as high bulk density gamma-alumina, and low or medium bulk density large pore gamma-alumina.

In some embodiments, a refractory metal oxide support comprises an oxygen storage component. As used herein, “OSC” refers to an oxygen storage component, that exhibits an oxygen storage capability and often is an entity that has multi-valent oxidation states and can actively release oxygen under an oxygen depleted environment and be re-oxidized (restore oxygen) under an oxygen enriched environment. Examples of suitable oxygen storage components include ceria and praseodymia and combinations thereof.

In some embodiments, the OSC is a mixed metal oxide composite, comprising ceria and/or praseodymia in combination with other metal oxides. Certain metal oxides that can be included in such mixed metal oxides include but are not limited to zirconium oxide (ZrO₂), titania (TiO₂), yttria (Y₂O₃), neodymia (Nd₂O₃), lanthana (La₂O₃), or mixtures thereof. For example, a “ceria-zirconia composite” means a composite comprising ceria and zirconia. In some embodiments, the ceria content in a mixed metal oxide composite ranges from about 25% to about 95%, preferably from about 50% to about 90%, more preferably from about 60% to about 70% by weight of the total mixed metal oxide composite (e.g., at least about 25% or at least about 30% or at least about 40% ceria content).

In some embodiments, the total ceria or praseodymia content in the OSC ranges from about 5% to about 99.9%, preferably from about 5% to about 70%, more preferably from about 10% to about 50% by weight of the total mixed metal oxide composite.

### Substrate Carrier

According to one or more embodiments, the substrate carrier for the exhaust gas emission mitigation catalytic material disclosed herein may be constructed of any material typically used for preparing automotive catalysts and will typically comprise a metal or ceramic honeycomb structure. The substrate typically provides a plurality of wall surfaces upon which the catalytic washcoat composition is applied and adhered, thereby acting as a carrier for the catalyst composition.

Exemplary metallic substrates include heat resistant metals and metal alloys, such as titanium and stainless steel as well as other alloys in which iron is a substantial or major component. Such alloys may contain one or more of nickel, chromium, and/or aluminum, and the total amount of these metals may advantageously comprise at least 15 wt. % of the alloy, e.g., 10-25 wt. % of chromium, 3-8 wt. % of aluminum, and up to 20 wt. % of nickel. The alloys may also contain small or trace amounts of one or more other metals, such as manganese, copper, vanadium, titanium and the like. The surface of metal carriers may be oxidized at high temperatures, e.g., 1000° C. and higher, to form an oxide layer on the surface of the substrate, improving the corrosion resistance of the alloy and facilitating adhesion of the washcoat layer to the metal surface.

Ceramic materials used to construct the substrate may include any suitable refractory material, e.g., cordierite, mullite, cordierite-α alumina, silicon nitride, zircon mullite, spodumene, alumina-silica magnesia, zircon silicate, sillimanite, magnesium silicates, zircon, petalite, α alumina, aluminosilicates and the like.

Any suitable substrate design may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which can be of any suitable cross-sectional shape, such as trapezoidal, rectangular, square, sinusoidal, hexagonal, oval, circular, and the like. Such structures may contain from about 60 to about 1200 or more gas inlet openings (i.e., “cells”) per square inch of cross section (cpsi), more usually from about 300 to 600 cpsi. The wall thickness of flow-through substrates can vary, with a typical range being between 0.002 and 0.1 inches. A representative commercially-available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry.

In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used in wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls.

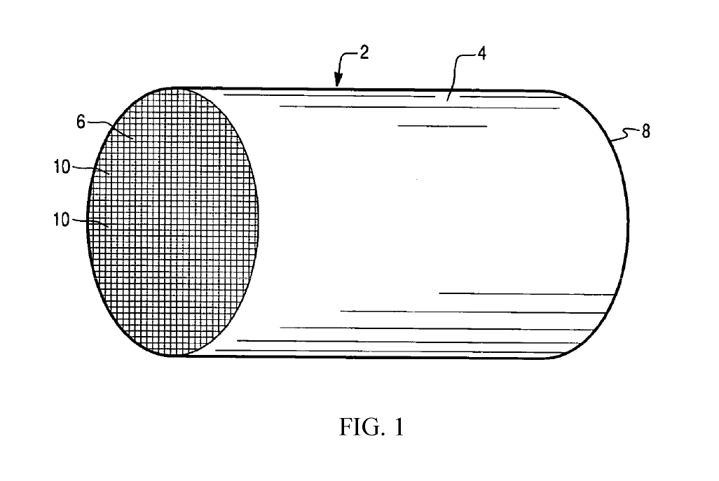

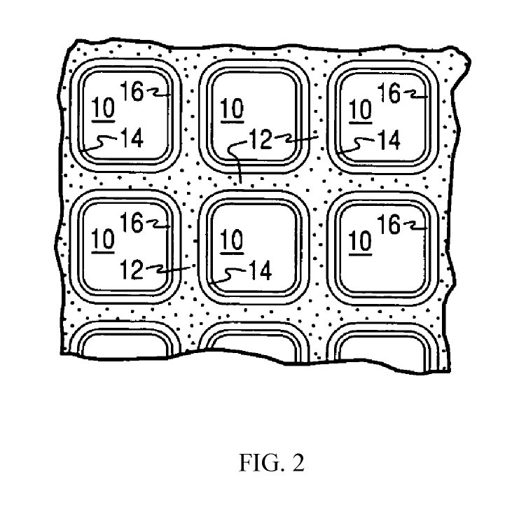

FIGS. 1 and 2 illustrate an exemplary substrate 2 in the form of a flow-through substrate coated with a washcoat composition as described herein. Referring to FIG. 1, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 2, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 2, walls 12 are so dimensioned and configured that gas flow passages 10 have a substantially regular polygonal shape. As shown, the washcoat composition can be applied in multiple, distinct layers if desired. In the illustrated embodiment, the washcoat consists of both a discrete bottom washcoat layer 14 adhered to the walls 12 of the carrier member and a second discrete top washcoat layer 16 coated over the bottom washcoat layer 14. For example, in some embodiments, bottom washcoat layer 14 comprises a PGM component and a first refractory metal oxide support and the top washcoat layer 16 comprises a plurality of palladium-rhodium nanoparticles and a second refractory metal oxide support.

The present invention can be practiced with one or more (e.g., 2, 3, or 4) washcoat layers and is not limited to the illustrated two-layer embodiment.

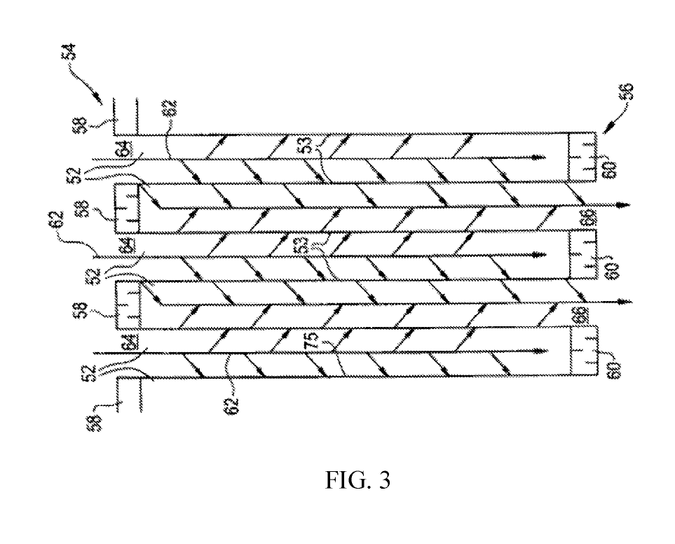

Alternatively, FIGS. 1 and 3 illustrate an exemplary substrate 2 in the form a wall flow filter substrate coated with a washcoat composition as described herein. As seen in FIG. 1, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58, and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalyzed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic material on the inlet and/or outlet walls of the element.

In alternative embodiments, one or more catalyst compositions may be deposited on an open cell foam substrate. Such substrates are well known in the art, and are typically formed of refractory ceramic or metallic materials.

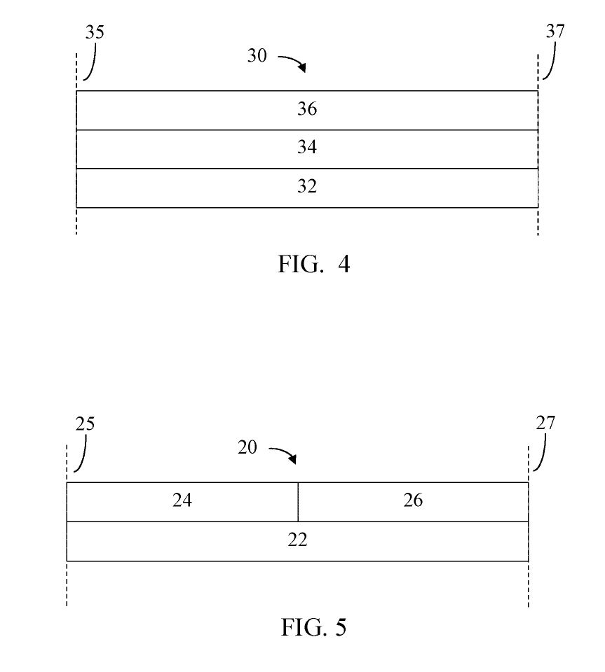

In some embodiments, the same substrate carrier is layered with at least two catalyst compositions contained in separate washcoat slurries in a horizontal configuration. For example, the same substrate carrier is coated with a washcoat slurry of one catalyst composition and a washcoat slurry of another catalyst composition, wherein each catalyst composition is different. This may be more easily understood by reference to FIG. 4, which shows an embodiment in which the first washcoat 34 is deposited on substrate carrier 32 and the second washcoat 36 is layered on top of the first washcoat 34 to render the coated substrate carrier 30.

The first washcoat 34 and the second washcoat 36 are deposited over the entire length of the substrate carrier 32, i.e., from inlet 35 to outlet 37. For example referring back to FIG. 4, the first washcoat 34 can represent a catalyst composition including a PGM component (e.g., palladium) coating substrate carrier 32, while the second washcoat 36 represents the catalyst composition including Pd—Rh nanoparticles layered on top of the first washcoat 34. In one embodiment, the first washcoat 34 can represent the catalyst composition including Pd—Rh nanoparticles, while the catalyst composition including a PGM component present in the second washcoat 36 is layered on top of the first washcoat zone 34.

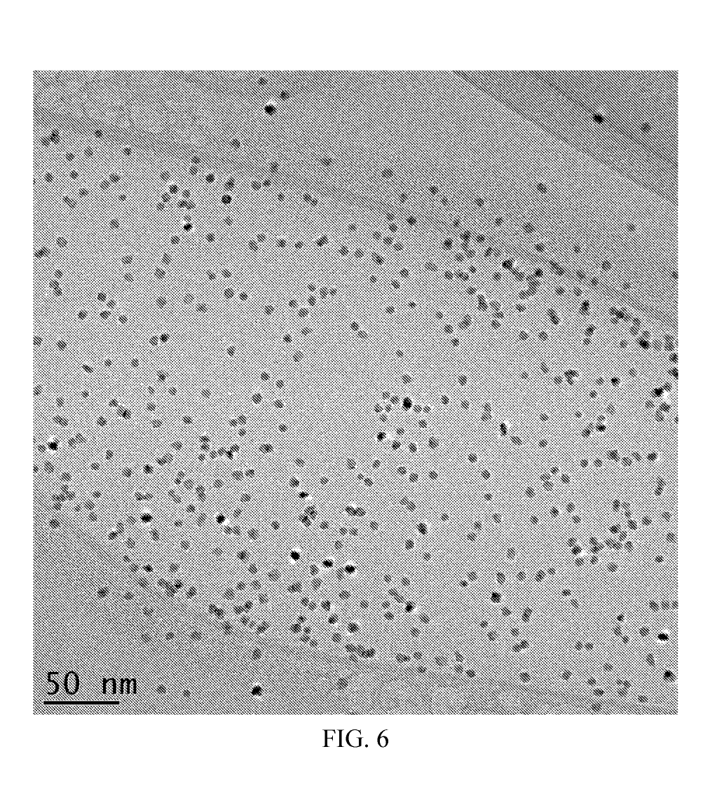

In some embodiments, the same carrier substrate is coated with at least two catalyst compositions contained in separate washcoat slurries in an axially zoned configuration. For example, the same carrier substrate can be coated with a washcoat slurry of one catalyst composition and a washcoat slurry of another catalyst composition, wherein each catalyst composition is different. This may be more easily understood by reference to FIG. 5, which shows an embodiment in which the first washcoat zone 24 and the second washcoat zone 26 are located side by side along the length of the carrier substrate 22. The first washcoat zone 24 of specific embodiments extends from the inlet end 25 of the carrier substrate 22 through the range of about 5% to about 95% of the length of the carrier substrate 22. The second washcoat zone 26 extends from the outlet 27 of the carrier substrate 22 through the range of about 5% to about 95% of the total axial length of the carrier substrate 22. The catalyst article having at least two catalyst compositions can be zoned onto the same carrier substrate. In some embodiments, a catalyst composition including a PGM component and a catalyst composition including Pd—Rh nanoparticles are zoned onto the same carrier substrate.

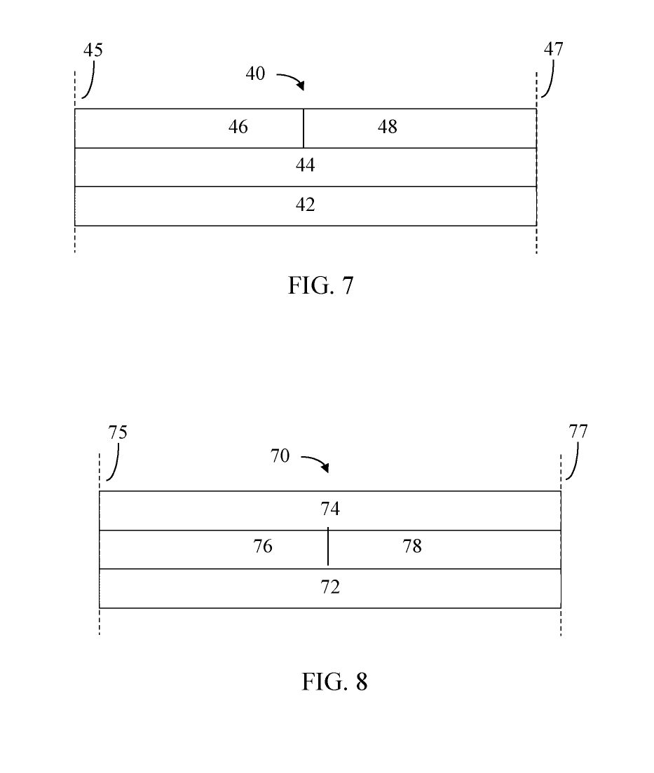

In other embodiments, a carrier substrate is coated with three catalyst compositions contained in separate washcoats, wherein the first catalyst composition is deposited onto the substrate carrier and the second catalyst composition and third catalyst compositions are deposited in an axially zoned configuration on top of the first catalyst composition. This may be more easily understood by reference to FIG. 7, which shows an embodiment in which the first washcoat 44 is deposited directly onto the substrate carrier 42 over the entire length of the substrate carrier 42, i.e., from inlet 45 to outlet 47. On top of the first washcoat 44 is deposited a second washcoat as zone 46 and a third washcoat as zone 48 on the carrier substrate 42. The washcoat zone 46 of specific embodiments extends from the inlet end 45 of the carrier substrate 42 through the range of about 5% to about 95% of the length of the carrier substrate 42. The other washcoat zone 48 extends from the outlet 47 of the carrier substrate 42 through the range of about 5% to about 95% of the total axial length of the carrier substrate 42. In other embodiments, a carrier substrate is coated with three catalyst compositions contained in separate washcoat slurries, wherein the first catalyst composition and the second catalyst composition are deposited in an axially zoned configuration as a bottom layer on the substrate carrier and the third catalyst composition is deposited as a single layer on top of the bottom zoned layer. This may be more easily understood by reference to FIG. 8, which shows an embodiment in which the first washcoat is deposited as zone 76 and a second washcoat is deposited as zone 78 on the carrier substrate 72 as the bottom layer. The washcoat zone 76 of specific embodiments extends from the inlet end 75 of the carrier substrate 72 through the range of about 5% to about 95% of the length of the carrier substrate 72. The other washcoat zone 78 extends from the outlet 77 of the carrier substrate 72 through the range of about 5% to about 95% of the total axial length of the carrier substrate 72. On top of the bottom layer washcoat 74 with a third catalyst composition is deposited over the entire length of the substrate carrier 72, i.e., from inlet 75 to outlet 77.

In describing the quantity of washcoat or catalytic metal components or other components of the composition, it is convenient to use units of weight of component per unit volume of catalyst substrate. Therefore, the units, grams per cubic inch (“g/in³”) and grams per cubic foot (“g/ft³”) are used herein to mean the weight of a component per volume of the substrate, including the volume of void spaces of the substrate. Other units of weight per volume such as g/L are also sometimes used. The total loading of the catalyst composition combined from all the layers on the carrier substrate, such as a monolithic flow-through substrate, is typically from about 0.5 to about 6 g/in³, and more typically from about 1 to about 5 g/in³. Total loading of the PGM component combined from all the layers and the Pd—Rh nanoparticles without support material present in all the layers is typically in the range of about 2 to about 200 g/ft³ for each individual carrier substrate.

It is noted that these weights per unit volume are typically calculated by weighing the catalyst substrate before and after treatment with the catalyst washcoat composition, and since the treatment process involves drying and calcining the coated catalyst substrate at high temperature, these weights represent an essentially solvent-free catalyst coating since all of the water of the washcoat slurry has been removed.

### Method of Making Catalyst Compositions

### A. Preparation of Palladium-Rhodium (Pd—Rh) Nanoparticle-Containing Catalyst Composition

Generally, palladium-rhodium (Pd—Rh) nanoparticles are prepared as follows. A solution S1 comprising a reducing agent, a surfactant and optionally a mineralizer is prepared. In one embodiment, a mixture of a reducing agent, a surfactant and optionally a mineralizer is pre-heated to temperature T1. Separately, a solution S2 comprising a Pd precursor and a Rh precursor is prepared that is optionally pre-heated to a temperature T2. Solution S2 is added into solution Si and the resulting mixture is heated to temperature T3. The mixture is maintained at temperature T3 to reduce at least a portion of the metal to a zero valance form by the reducing agent in the presence of a surfactant and optionally a mineralizer to form a colloidal solution of Pd—Rh nanoparticles. If Pd—Rh nanoparticles are prepared in water, T1 and T2 are typically in the range of about 25° C. to about 100° C. and T3 is typically about 60° C. to about 100° C. In some embodiments, T1 and T3 are the same temperature. If Pd—Rh nanoparticles are prepared in ethylene glycol, T1 and T2 are typically about 25° C. to about 180° C. and T3 is typically about 100° C. to about 180° C. In one embodiment, the prepared Pd—Rh nanoparticles can be used without purification or they can be exposed to dialysis to remove any excess salt formed during nanoparticle formation or optionally subjected to a concentrating step to increase the concentration of Pd—Rh nanoparticles in the dispersion. For example, in some embodiments, the Pd-concentration of a purified aqueous suspension of Pd—Rh nanoparticles post dialysis treatment ranges from about 1000 ppm to about 5000 ppm. In other embodiments, the Rh-concentration of a purified aqueous suspension of Pd—Rh nanoparticles post dialysis treatment ranges from about 500 ppm to about 2000 ppm. In some embodiments, the weight ratio of Pd to Rh ranges from about 0.15 to about 2.0, preferably from about 1 to about 3.

The choice of Rh precursor and Pd precursor (e.g., salt of each PGM component), reducing agent, surfactant and optional mineralizer will impact the shape and size of the dispersible Pd—Rh nanoparticles that are produced. The amount and type of surfactant should be adequate to keep the Pd—Rh nanoparticles free of large, micron-sized agglomerates as the reducing agent reacts to make zero valance metals. The reducing agent should be present in an amount to reduce all of the metal with a slight amount of excess. The optional mineralizer enforces growth of specific Pd and/or Rh facets. During preparation, the salt of the Pd component and/or Rh component may be present in the aqueous solution in an amount of about 0.01% to about 2% by weight of the solution, the surfactant may be present in the aqueous solution in an amount of about 0.1% to about 10%, more preferably about 0.1% to about 5%, by weight of the solution, the reducing agent may be present in the aqueous solution in an amount of about 0.1% to about 10%, more preferably about 0.1% to about 5%, by weight of the solution, the optional mineralizer may be p resent in an amount of about 0% to about 10%, more preferably about 0% to about 5%.

In some embodiments, the precursor compounds include salts selected from the group consisting of nitrates, halogenides, carboxylates, carboxylate esters, alcoholates, and mixtures of two or more thereof.

Sources of support materials may include any oxide or hydroxide or oxyhydroxide of the desired support material, generally those that are water-dispersible. Alumina, for example, may be provided as a suspension of nano-sized alumina or aluminum oxyhydroxide particles. An exemplary suspension of aluminum oxyhydroxide particles contains boehmite (AlOOH) or pseudoboehmite. The suspension of alumina particles may comprise aluminum oxide, aluminum hydroxide, aluminum oxyhydroxide, or a mixture thereof. Anions such as nitrate, acetate, citrate and formate may coexist in a colloidal alumina suspension. In one or more embodiments, the colloidal alumina is suspended in deionized water at a solids loading of about 5% to about 50% by weight. Pre-calcined supports, where used, are commercially available.

Suitable surfactants include, but are not limited to, water-soluble polymers. Molecular weights of exemplary polymers are generally about 1,000 to about 500,000 g/mol, and more preferably about 5,000 to about 100,000 g/mol. Polymers include homopolymers and copolymers, with linear or branched molecular structures. Suitable monomers from which such water-soluble polymers may be obtained include, but are not limited to, unsaturated carboxylic acids and esters, amides and nitriles, N-vinylcarboxyamides, alkylene oxides. Preferred water-soluble polymers are, for example, selected from poly(vinylalcohol), poly(vinylpyrrolidone), poly(ethyleneimine), poly(acrylic acid), polyaspartic acid, carbohydrates, and/or alkali metal citrates. Examples of further water-soluble polymers are provided, for example, in U.S. Patent Application Publication No. 2011/0206753 to Karpov et al., which is incorporated herein by reference.

Suitable reducing agents include, but are not limited to, alcohols or further alcohol group containing organic molecules. Alcohols include ethanol, propanol, diethylene glycol, monoethylene glycol, and any polyethylene glycol, for example, tetraethylene glycol. Preferred alcohol-containing organic molecules include citric acid or ascorbic acid. Further possible reducing agents include inorganic materials such as sodium borohydride (NaBH4) or hydrogen.

Optionally, pH regulators may be used. Suitable pH regulators, if needed, may comprise acetic acid, ascorbic acid (C₆H₈O₆), citric acid, oxalic acid (C₂H₂O₄), formic acid (HCOOH), chloric acid, sodium hydroxide, and/or ammonium hydroxide.

Suitable mineralizers include, but are not limited to, potassium bromide, sodium bromide, ammonium bromide, tetramethylammonium, cetyltrimethylammonium bromide, and combinations thereof.

Catalyst compositions containing such nanoparticles are prepared as follows. In one embodiment, Pd—Rh nanoparticles and a refractory metal oxide support are dispersed in or mixed with water to form an aqueous colloidal solution resulting in a catalytic material solution with an average aggregated particle size of less than 500 nm. In another embodiment, powder containing nanoparticles of a refractory metal oxide support can be directly dispersed in an aqueous colloidal solution of Pd—Rh nanoparticles to form an aqueous colloidal solution resulting in a catalytic material solution with an average aggregated particle size of less than 500 nm. Pd—Rh nanoparticles may be obtained as previously discussed herein. Nanoparticles of a refractory metal oxide support may be obtained from a colloidal solution of the refractory metal oxide.

The catalytic material solution is dried and calcined to form a catalyst composition, wherein the Pd—Rh nanoparticles are dispersed and are present throughout the support material.

In some embodiments, a majority of the Pd—Rh nanoparticles are inside aggregated particles of the support material.

In another embodiment, a dispersion containing Pd—Rh nanoparticles is impregnated on a refractory support using an incipient wetness technique.

Generally, a dispersion of Pd—Rh nanoparticles is added to a catalyst support material in an amount (volume) roughly equivalent to the pore volume of the catalyst support material.

Prior this addition, the dispersion of Pd—Rh nanoparticles can be optionally concentrated or diluted. Capillary action draws the solution into the pores of the support. The catalyst can then be dried and calcined to drive of volatile components within the solution, depositing the Pd—Rh nanoparticles onto internal and external surfaces of the support material.

Impregnation may be repeated several times to achieve target Pd and/or Rh concentration on the support.

### B. Preparation of PGM Component Containing-Catalyst Composition

Preparation of the PGM component-containing catalyst composition typically comprises impregnating a refractory metal oxide support in particulate form with a PGM solution, such as a palladium solution.

Typically, a metal (PGM) precursor is dissolved in an aqueous or organic solvent and then the resulting solution is added to a catalyst support material in an amount (volume) roughly equal to the pore volume of the catalyst support material. Capillary action draws the solution into the pores of the support. Solution added in excess of the support pore volume causes the solution transport to change from a capillary action process to a diffusion process, which is much slower. The catalyst can then be dried and calcined to drive off volatile components within the solution, depositing the metal (PGM) on the support material surface. The maximum loading is limited by the solubility of the precursor in the solution. The concentration profile of the impregnated material depends on the mass transfer conditions within the pores during impregnation and drying.

The support particles are typically dry enough to absorb substantially all of the solution to form a moist solid. Aqueous solutions of water soluble compounds or complexes of the PGM component are typically utilized, such as palladium or tetraammine palladium.

Following treatment of the support particles with the PGM solution, the particles are dried, such as by heat treating the particles at elevated temperature (e.g., 100-150° C.) for a period of time (e.g., 1-3 hours), and then calcining to convert the PGM component to a more catalytically active form. An exemplary calcination process involves heat treatment in air at a temperature of about 400 to about 550° C. for about 1 to about 3 hours. The above process can be repeated as needed to reach the desired level of PGM impregnation. In some embodiments, the calcining is replaced with precipitation of the PGM impregnated refractory metal oxide support. The resulting material can be stored as a dry powder.

### Substrate Coating Process

The above-noted catalyst composition(s), i.e., a PGM component impregnated onto a refractory metal oxide support and Pd—Rh nanoparticles dispersed on a refractory oxide material are mixed with water to form individual slurries for purposes of coating a catalyst carrier substrate as described herein. In addition to the catalyst particles, the slurries may optionally contain additional metal oxide supporting materials, a binder, water-soluble or water-dispersible catalyst stabilizers (e.g., barium acetate), promoters (e.g., lanthanum nitrate), and/or surfactants.

Either or both slurries can be milled to enhance mixing of the particles, reducing particle sizes and formation of a homogenous material. The milling can be accomplished in a ball mill, continuous mill, or other similar equipment, and the solids content of the slurry may be, e.g., about 10-50 wt. %, more particularly about 20-40 wt. %. In one embodiment, one or both slurries is characterized by a post-milling D₉₀ particle size of about 10 to about 40 microns, preferably about 10 to about 30 microns, more preferably about 10 to about 20 microns (or less than about 40, or less than about 25, or less than about 18, or less than about 10, with each value being understood to have a lower boundary of 0%). The D₉₀ is defined as the particle size at which 90% of the particles have a finer particle size.

The slurries are then coated on the catalyst substrate using any washcoat technique known in the art. Thereafter, the coated substrate is dried at an elevated temperature (e.g., 100-150° C.) for a period of time (e.g., 1-3 hours) and then calcined by heating, e.g., at 400-600° C., typically for about 10 minutes to about 3 hours. In some embodiments, the coated substrate may be dried and/or calcined between each individual layer.

After calcining, the catalyst loading obtained by the above described washcoat technique can be determined through calculation of the difference in coated and uncoated weights of the substrate.

As mentioned previously, each catalyst composition can be applied as a single layer to generate a multi-layered (e.g., two-layered) catalyst substrate. For example, the bottom layer (e.g., layer 14 of FIG. 2) can comprise an catalyst composition having a PGM component dispersed onto a first refractory metal oxide support and the top layer (e.g., layer 16 of FIG. 2) can comprise a catalyst composition of the invention including a plurality of Pd—Rh nanoparticles dispersed onto a second refractory metal oxide support. The relative amount of the catalyst composition in each layer can vary. As generally described herein, the number and composition of layers can vary and similarly the amount of catalyst composition in each layer can vary.

### Method of Hydrocarbon (HC), Carbon Monoxide (CO), and Nitrogen Oxides (NOₓ) Conversion

In general, hydrocarbons, carbon monoxide, and nitrogen oxides present in the exhaust gas stream of a combustion engine are converted to carbon dioxide, nitrogen, oxygen and water by contacting the catalysts coated on the monolith according to the equations shown below:

2NOₓ→xO₂+N₂

2CO+O₂→2CO₂

CₓH₂ₓ₊₂+[(3x+1)/2]O₂→xCO₂+(x+1)H₂O

Typically, the finished catalysts need to go through accelerated ageing protocols either on a lab reactor or on an engine bench to simulate the duration of real life driving. The performance of aged catalysts is evaluated either on a transient reactor, engine bench or an actual vehicle using certain government certification drive cycles. The performance is expressed in terms of residual (or emission from the tail pipe to the environment) HC, CO and NOₓ in mg/mile or percentage of conversions.

As such, aspects of the current invention are directed towards a method for reducing one or more of HC, CO, and NOₓ levels in an exhaust gas stream from a lean burn engine, comprising contacting the gas stream with a catalyst article as described by the enclosed embodiments.

In some embodiment, the catalyst article reduces the combined CO, HC, and NOₓ levels in the exhaust gas stream by at least about 50%, at least about 60%, at least about 70%, at least about 80%, at least about 90%, or at least about 95% compared to the CO, HC, and NOₓ levels in the exhaust gas emission stream prior to contact with the catalyst article, with each value being understood to have an upper boundary of 100%.

In some embodiments, the catalyst article reduces the level of HC in the exhaust gas stream by converting HCs to carbon dioxide and water. In some embodiments, the catalyst article reduces at least about 60%, at least about 70%, at least about 75%, at least about 80%, at least about 90%, or at least about 95% of the amount of HC present in the exhaust gas stream prior to contact with the catalyst composition, with each value being understood to have an upper boundary of 100%.

In another embodiment, the catalyst article reduces the level of CO in the exhaust gas stream by converting CO to carbon dioxide (COz). In some embodiments, the catalyst article reduces at least about 60%, at least about 70%, at least about 75%, at least about 80%, at least about 90%, or at least about 95% of the amount of CO present in the exhaust gas stream prior to contact with the catalyst composition, with each value being understood to have an upper boundary of 100%.

In another embodiment, the catalyst article reduces the level of NOₓ in the exhaust gas stream by converting NOₓ to nitrogen and oxygen. In some embodiments, the catalyst article reduces at least about 60%, or at least about 70%, at least about 75%, at least about 80%, at least about 90%, or at least about 95% of the amount of NOₓ present in the exhaust gas stream prior to contact with the catalyst composition, with each value being understood to have an upper boundary of 100%.

Before describing several exemplary embodiments of the invention, it is to be understood that the invention is not limited to the details of construction or process steps set forth in the following description. The invention is capable of other embodiments and of being practiced in various ways. In the following, preferred designs are provided, including such combinations as recited used alone or in unlimited combinations, the uses for which include catalysts, systems, and methods of other aspects of the present invention.

### EXAMPLES

The following non-limiting examples shall serve to illustrate the various embodiments of the present invention.

### Example 1: Preparation of Pd—Rh Nanoparticles with an Average Particle Size of about 5 nm

26.30 g of poly(vinyl pyrrolidone) (PVP, MW=55,000), 14.97 g of ascorbic acid, and 1.25 g of KBr were added to 400 g water and preheated to a temperature T1 (T1=90° C. or 100° C.) in a jacketed glass reactor under mechanic stirring for 30 minutes to form an aqueous solution S1. Separately, an aqueous solution S2 containing 8.55 g of Na₂PdCl₄ (Pd-content=18.88 wt. %), 21.61 g of Rh(OAc)₃ (Rh-content=4.98 wt. %) and 50 g water was prepared at a temperature T2 (T2=25° C.). Solution S2 was added into solution Si with a syringe pump at a rate of 250 mL/hour. Then, 50 g water was added with a syringe pump at a rate of 250 mL/hour. The reaction was heated to a temperature T3 and maintained at T3 for 20 hours (if T3=90° C.) or 3 hours (if T3=100° C.) to produce an aqueous colloidal suspension of Pd—Rh nanoparticles. The Pd—Rh nanoparticles were purified by dialysis. The suspension was placed into a Fisherbrand® regenerated cellulose dialysis tube. The tube was closed from both sides and placed in a container containing 10 kg water. Water was exchanged several times to reduce Na-content in the product to about 10 ppm. This process was repeated several times with Pd and Rh concentrations of purified products summarized in the Table 1. FIG. 6 provides a TEM image of prepared purified Pd—Rh nanoparticles particles with a scale of 50 nm.

TABLE 1
Pd and Rh concentrations of prepared purified aqueous suspensions
containing Pd—Rh nanoparticles according to Example 1.

| Example Number | Pd-concentration [ppm] | Rh-concentration [ppm] |
|---|---|---|
| 1-A | 2440 | 1590 |
| 1-B | 1290 | 775 |
| 1-C | 1870 | 1220 |
| 1-D | 2220 | 1450 |
| 1-E | 2350 | 1470 |
| 1-F | 2610 | 1630 |
| 1-G | 2320 | 1390 |
| 1-H | 2251 | 1319 |
| 1-I | 1970 | 1185 |
| 1-J | 2400 | 1470 |

### Example 2: Preparation of Pd—Rh Nanoparticles Supported on Acid Dispersible Boehmite Alumina Powder

Acid dispersible boehmite alumina powder (Al₂O₃ content=80.7 wt. %) was dispersed in an aqueous colloidal solution containing Pd—Rh nanoparticles prepared according to Example 1 (Materials 1-A-1D from Table 1) under vigorous stirring. The resulting slurry was spray-dried using a Buchi Mini Spray-Drier B-290 (outlet temperature 120° C.). The spray-dried powder was calcined at 550° C. for two hours in air to provide Pd—Rh-nanoparticles supported on the boehmite alumina powder. Pd-content and Rh-content of the prepared PdRh/boehmite alumina powders are listed in Table 2.

TABLE 2
Pd and Rh contents of the prepared PdRh/boehmite alumina powders.

| Example Number | Pd-content [wt. %] | Rh-content [wt. %] |
|---|---|---|
| 2-A | 0.42 | 0.27 |
| 2-B | 0.52 | 0.29 |
| 2-C | 0.62 | 0.37 |
| 2-D | 0.56 | 0.35 |
| 2-E (Mixture of 2-B, 2-C,) | 0.56 | 0.33 |
| 2-D | | |

### Example 3: Preparation of Pd—Rh Nanoparticles Supported on La-Stabilized γ-Al₂O₃

Aqueous suspensions containing Pd—Rh nanoparticles prepared according to Example 1 were impregnated by incipient wetness impregnation onto La-stabilized γ-Al₂O₃. The impregnated material was calcined in a muffle furnace at 550° C. for 2 h in air. The impregnation and calcination was repeated several times to achieve a Rh content of about 0.5 wt. %. In total, 590 g of calcined powder containing Pd—Rh nanoparticles supported on La-stabilized γ-Al₂O₃ with Pd-content of 0.82 wt. % and Rh-content of 0.48 wt. % was produced.

In each of the following Examples 4-7, a flow-through monolith having the following characteristics was used: a volume of 20.4 in³ (0.33 L), a cell density of 600 cells per square inch, and a wall thickness of approximately 100 μm.

### Example 4: Preparation of Comparative Sample A

The washcoat was prepared as follows to deliver the recited amounts on a dry gain basis. 2.55 g/in³ of a ceria-zirconia-oxide I (cerium oxide: 30 wt. %, zirconium oxide: 50 wt. %, lanthanum oxide: 5 wt. %; yttrium oxide: 5 wt. %) was impregnated by incipient wetness with a palladium nitrate solution to support 86 wt. % of the palladium for the entire washcoat. The impregnated powder was calcined in air at 550° C. for 2 hours. 0.85 g/in³ of a non-stabilized alumina oxide (100 wt. % Al₂O₃) was impregnated by incipient wetness with an aqueous solution containing a mixture of palladium nitrate and rhodium nitrate to support 14 wt. % of the palladium for the entire washcoat and 100 wt. % of the rhodium for the entire washcoat. The impregnated powder was calcined in air at 550° C. for 2 hours.

The calcined impregnated powder of Pd and Rh on alumina (PdRh/Al₂O₃) was dispersed in water and acetic acid at a pH in the range from 3.0 to 5.0. The slurry was milled to a particle size of D₉₀ less than 25 micrometers. Into this slurry, barium acetate corresponding to 0.16 g/in³ BaO and zirconia acetate corresponding to 0.05 g/in³ ZrO₂ were added. Acetic acid was added to maintain pH in the range from 4.0 to 5.0. Into this slurry, the calcined impregnated powder of Pd on ceria-zirconia oxide (Pd/CeZr-oxide I) was dispersed, and the slurry was milled to a particle size of D₉₀ less than 18 micrometers. The combined final slurry was coated onto a monolith, dried at 110° C. in air and calcined at 550° C. in air. The palladium loading was 46 g/ft³ Pd, the rhodium loading was 4 g/ft³ Rh.

### Example 5: Preparation of Comparative Sample B

The washcoat was prepared as follows to deliver the recited amounts on a dry gain basis. 2.55 g/in³ of a ceria-zirconia-oxide I (cerium oxide: 30 wt. %, zirconium oxide: 60 wt. %, lanthanum oxide: 5 wt. %; yttrium oxide: 5 wt. %) was impregnated by incipient wetness with a palladium nitrate solution to support 86 wt. % of the palladium for the entire washcoat. The impregnated powder was calcined in air at 550° C. for 2 hours. 0.8559 g/in³ of Pd—Rh nanoparticles supported on acid dispersible boehmite alumina powder prepared according to Example 2A (containing 0.0036 Pd g/in³ and 0.0023 Rh g/in³ from Pd—Rh nanoparticles and 0.85 g/in³ of alumina powder) was used as is.

The calcined powder of Pd and Rh on alumina (Pd—Rh nanoparticles/Al₂O₃) was dispersed in water and acetic acid at a pH in the range from 3.0 to 5.0. The slurry was milled to a particle size of D₉₀ less than 25 micrometers. Into this slurry, barium acetate corresponding to 0.16 g/in³ BaO and zirconia acetate corresponding to 0.05 g/in³ ZrO₂ were added. Acetic acid was added to maintain pH in the range from 4.0 to 5.0. Into this slurry, calcined impregnated powder of Pd on ceria-zirconia (Pd/CeZr-oxide I) was dispersed, and the slurry was milled to a particle size of D₉₀ less than 18 micrometers. The final slurry was coated onto a monolith, dried at 110° C. in air and calcined at 550° C. in air. The palladium loading was 46 g/ft³ Pd, the rhodium loading was 4 g/ft³ Rh.

Catalyst compositions (g/in³) of Comparative Examples 4 and 5 are summarized in Table 3.

TABLE 3
Catalyst compositions (g/in³) of Comparative Examples 4 and 5

| | Example 4 | Example 5 |
|---|---|---|
| | (COMPARATIVE | (COMPARATIVE |
| | SAMPLE A) | SAMPLE B) |
| CeZr-oxide I | 2.55 | 2.55 |
| Al₂O₃ | 0.85 | |
| Acid dispersible boehmite | | 0.85 |
| alumina powder | | |
| BaO | 0.16 | 0.16 |
| ZrO₂ | 0.05 | 0.05 |
| Pd from Pd-Nitrate | 0.0266 | 0.0230 |
| Rh from Rh-Nitrate | 0.0023 | |
| Pd from Pd—Rh nanoparticles | | 0.0036 |
| Rh from Pd—Rh | | 0.0023 |
| nanoparticles | | |
| Total coat | 3.639 | 3.639 |

### Example 6: Preparation of Comparative Sample C

The bottom coat was prepared as follows to deliver the recited amounts on a dry gain basis. 1.75 g/in³ of a ceria-zirconia-oxide II (cerium oxide: 40 wt. %, zirconium oxide: 50 wt. %, lanthanum oxide: 5 wt. %; yttrium oxide: 5 wt. %) was impregnated by incipient wetness with a palladium nitrate solution to support 70 wt. % of the palladium for the entire bottom coat. The impregnated powder was calcined in air at 550° C. for 2 hours. 0.5 g/in³ of a La-stabilized alumina oxide (96 wt. % Al₂O₃, 4 wt. % La₂O₃) was impregnated by incipient wetness with a palladium nitrate solution to support 30 wt. % of the palladium for the entire bottom coat. The impregnated powder was calcined in air at 550° C. for 2 hours.

Calcined impregnated powder of Pd on La-stabilized alumina (Pd/Al₂O₃) was dispersed in water and acetic acid at a pH in the range from 3.0 to 5.0. The slurry was milled to a particle size of D₉₀ less than 25 micrometers. Into this slurry, barium sulphate corresponding to 0.15 g/in³ BaO and dispersible alumina corresponding to 0.05 g/in³ Al₂O₃ were added. Acetic acid was added to maintain pH in the range from 4.0 to 5.0. Into this slurry, calcined impregnated powder of Pd on ceria-zirconia oxide II (Pd/CeZr-oxide II) was dispersed, and the slurry was milled to a particle size of D₉₀ less than 18 micrometers. The final slurry was coated onto a monolith, dried at 110° C. in air and calcined at 550° C. in air. The palladium loading in the bottom coat was 39.2 g/ft³ Pd.

The top coat was prepared as follows to deliver the recited amounts on a dry gain basis. 0.82 g/in³ of a non-stabilized alumina oxide (100 wt. % Al₂O₃) was impregnated by incipient wetness with an aqueous solution containing a mixture of palladium nitrate and rhodium nitrate to support 100 wt. % of the palladium for the entire top coat and 100 wt. % of the rhodium for the entire top coat. The impregnated powder was calcined in air at 550° C. for 2 hours.

Calcined impregnated powder of Pd and Rh on the non-stabilized alumina (PdRh/Al₂O₃) was dispersed in water and acetic acid at a pH in the range from 4.0 to 5.0. The slurry was milled to a particle size of D₉₀ less than 18 micrometers. Into this slurry, dispersible alumina corresponding to 0.03 g/in³ Al₂O₃ was added. Acetic acid was added to maintain pH in the range from 4.0 to 5.0. The final slurry was coated onto a monolith, dried at 110° C. in air and calcined at 550° C. in air. The palladium loading in the top coat was 8.0 g/ft³ Pd, and the rhodium loading in the top coat was 4.7 g/ft³ Rh.

### Example 7: Preparation of Inventive Sample A

The bottom coat was prepared in exactly the same manner as the bottom coat of the Comparative Example 6.

The top coat was prepared as follows to deliver the recited amounts on a dry gain basis. 0.8273 g/in³ of Pd—Rh nanoparticles supported on acid dispersible boehmite alumina powder prepared according to Example 2E (containing 0.0046 Pd g/in³ and 0.0027 Rh g/in³ from Pd—Rh nanoparticles and 0.82 g/in³ of alumina) was used as is.

Calcined impregnated powder of Pd and Rh on the non-stabilized alumina (PdRh/Al₂O₃) was dispersed in water and acetic acid at a pH in the range from 4.0 to 5.0. The slurry was milled to a particle size of D₉₀ less than 18 micrometers. Into this slurry, dispersible alumina corresponding to 0.03 g/in³ Al₂O₃ was added. Acetic acid was added to maintain pH in the range from 4.0 to 5.0. The final slurry was coated onto a monolith, dried at 110° C. in air and calcined at 550° C. in air. The palladium loading in the top coat was 8.0 g/ft³ Pd, and the rhodium loading in the top coat was 4.7 g/ft³ Rh.

Catalyst compositions (g/in³) of Comparative Example 6 and Inventive Example 7 are summarized in Table 4.

TABLE 4
Catalyst compositions (g/in³) of Comparative Example 6 and
Inventive Example 7

| | |
|---|---|
| Example 6 | Example 7 |
| (COMPARATIVE | (INVENTIVE |
| SAMPLE C) | SAMPLE) |

Bottom Coat

| | | |
|---|---|---|
| CeZr-oxide II | 0.5 | 0.5 |
| Al₂O₃ | 1.75 | 1.75 |
| BaO | 0.15 | 0.15 |
| Dispersible alumina | 0.05 | 0.05 |
| Pd from Pd-Nitrate | 0.0227 | 0.0227 |

Top Coat

| | | |
|---|---|---|
| Al₂O₃ | 0.82 | |
| Acid dispersible boehmite | | 0.82 |
| alumina powder | | |
| Dispersible alumina | 0.03 | 0.03 |
| Pd from Pd-Nitrate | 0.0046 | |
| Rh from Rh-Nitrate | 0.0027 | |
| Pd from Pd—Rh nanoparticles | | 0.0046 |
| Rh from Pd—Rh nanoparticles | | 0.0027 |
| Total coat | 3.330 | 3.330 |

### Example 8: Lab Reactor Evaluation

Core samples having dimensions of 1″×1.5″ (2.5 cm×3.8 cm) from the catalyst compositions of Examples 4-7 were aged at 1050° C. for 12 hours using a cyclic rich lean gas composition on a lab reactor. After aging, the catalysts were evaluated using a transient reactor with New European Driving Cycle (NEDC). Table 5 provides residual percentages of HC, CO, and NOₓ after the entire testing cycle. From the table, it can be concluded that Pd—Rh nanoparticles formulated in a single-layer catalyst design do not provide an advantage over co-impregnation of Pd and Rh nitrates (compare Comparative Examples 4 and 3). On the other hand, Pd—Rh nanoparticles formulated in a double-layer catalyst design provide an advantage over co-impregnation of Pd and Rh nitrates (compare Comparative Sample C (Example 6) and Inventive Sample (Example 7)).

TABLE 5
Transient reactor data of core samples from Comparative Examples 4,
5, 6 and Inventive Example 7 after aging at 1050° C.

| | | | | Resid- |
|---|---|---|---|---|
| | | Residual | Residual | ual |
| | | HC | CO | NO |
| | | by flow | by flow | by flow |
| Core sample | Features | [%] | [%] | [%] |
| Comparative | Single-Layer Design | 7.2 | 16.8 | 5.2 |
| Sample A | Co-impregnated Pd and | | | |
| (Example 4) | Rh nitrates on alumina | | | |
| Comparative | Single-Layer Design | 7.3 | 18.0 | 5.8 |
| Sample B | Pd—Rh nanoparticles | | | |
| (Example 5) | supported on alumina | | | |
| Comparative | Double-Layer Design | 8.6 | 21.1 | 5.2 |
| Sample C | Co-impregnated Pd and | | | |
| (Example 6) | Rh nitrates on alumina in | | | |
| | the top coat | | | |
| Inventive | Double-Layer Design | 8.5 | 19.1 | 4.4 |
| Sample | Pd—Rh nanoparticles on | | | |
| (Example 7) | alumina in the top coat | | | |

### Example 9: Full Size Reference Catalyst Sample

This example describes the composition and preparation of a full size reference catalyst (4.16″ in diameter and 4.5″ long) comprising a two-layer washcoat architecture. The bottom coat, with a washcoat loading of 2.85 g/in³, contained 0.8 wt. % palladium, 17.6 wt. % of a high surface area low density alumina (BET surface area: 150 m²/g), 29.9 wt. % of a high surface area high density alumina (BET surface area: 150 m²/g), 10.5 wt. % cerium oxide, 21.0 wt. % zirconium oxide, 10.5 wt. % barium oxide, 8.8 wt. % of rare earth metal oxides as stabilizers and 0.9 wt. % binding material. Pd was uniformly distributed on various supports with the usage of soluble Pd precursor in the bottom coat. The top coat, with a washcoat loading of 1.95 g/in³, contained 0.2 wt. % palladium, 0.1 wt. % rhodium, 25.7 wt. % of the same high surface area low density alumina, 25.7 wt. % of the same high density alumina 7.2 wt. % cerium oxide, 26.0 wt. % zirconium oxide, 13.1 wt. % of rare earth metal oxides as stabilizers and 2.1 wt. % binding material. A soluble Pd precursor was impregnated and thermally fixed on the OSC material in the top coat. A soluble Rh precursor was impregnated and thermally fixed on the high density alumina support in the top coat. The slurries were milled to reduce the average particle size and then coated on a ceramic substrate having a cell density of 600 cells per square inch and a wall thickness of 4 mil (about 100 μm).

### Example 10: Full Size Comparison Catalyst Sample 1

This example describes the composition and preparation of comparison catalyst sample #1, which had the exact washcoat architecture and composition as the reference catalyst. The bottom coat was prepared exactly the same way as the reference catalyst. But in the top coat, 15% by weight of the Pd was impregnated and thermally fixed on the OSC material using a soluble Pd precursor. The remaining 85% by weight Pd and 100% by weight Rh were added as Pd—Rh nanoparticles with Pd to Rh weight ratio of 1.7 to 1. In this comparison example, Pd—Rh nanoparticles were first deposited onto a high surface area high density alumina support as described in Example 3 before adding into the top coat slurry. The slurries were milled to reduce the average particle size and then coated on a ceramic substrate having a cell density of 600 cells per square inch and a wall thickness of 4 mil (about 100 μm).

### Example 11: Full Size Comparison Catalyst Sample 2

This example describes the preparation of comparison catalyst sample #2, which also had the exact washcoat architecture and composition as the reference catalyst and comparison catalyst sample #1. The bottom coat was prepared exactly the same way as the reference catalyst sample and comparison catalyst sample #1. In the top coat, 15% by weight of the Pd was also impregnated and thermally fixed on the OSC material using a soluble Pd precursor. The remaining 85% by weight Pd and 100% by weight Rh were also added as Pd—Rh nanoparticles which have Pd to Rh weight ratio at 1.7 to 1. But different from comparison catalyst #1, Pd—Rh nanoparticles were first deposited onto high surface area low density alumina support described in Example 3 before adding into the top coat slurry. The slurries were milled to reduce the average particle size and then coated on a ceramic substrate having a cell density of 600 cells per square inch and a wall thickness of 4 mil (about 100 μm).

### Example 12: Engine Evaluation of Reference Catalyst Sample, Comparison Catalyst Sample 1, and Comparison Catalyst Sample 2

Reference catalyst sample, comparison catalyst sample 1, and comparison catalyst sample 2 were aged on a gasoline engine bench for 100 hours using a ZDAKW (Zyklus des Abgaszentrums deutscher Automobilhersteller zur Katalysatorweiterentwicklung) aging cycle with a catalyst peak temperature of 1030° C. These catalysts were then evaluated on an Audi 2 L turbo engine using New European Driving Cycle (NEDC).

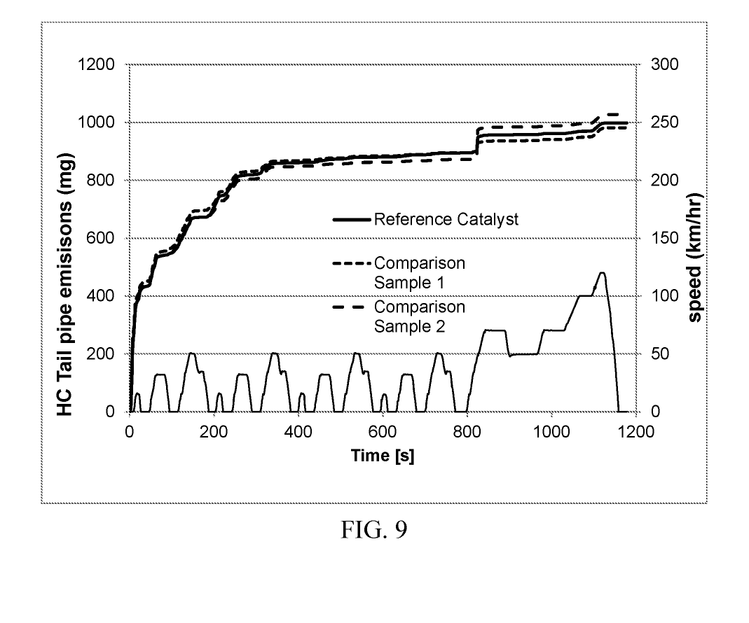

FIG. 9 shows the accumulated tail pipe HC emissions of the reference catalyst sample, comparison catalyst sample 1, and comparison catalyst sample 2 under the NEDC drive cycle

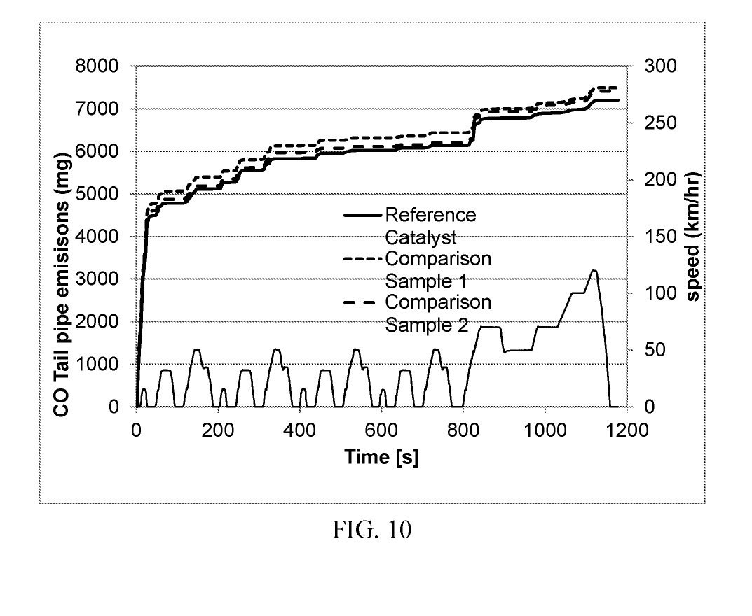

FIG. 10 shows the accumulated tail pipe CO emissions of the reference catalyst sample, comparison catalyst sample 1, and comparison catalyst sample 2 under the NEDC drive cycle

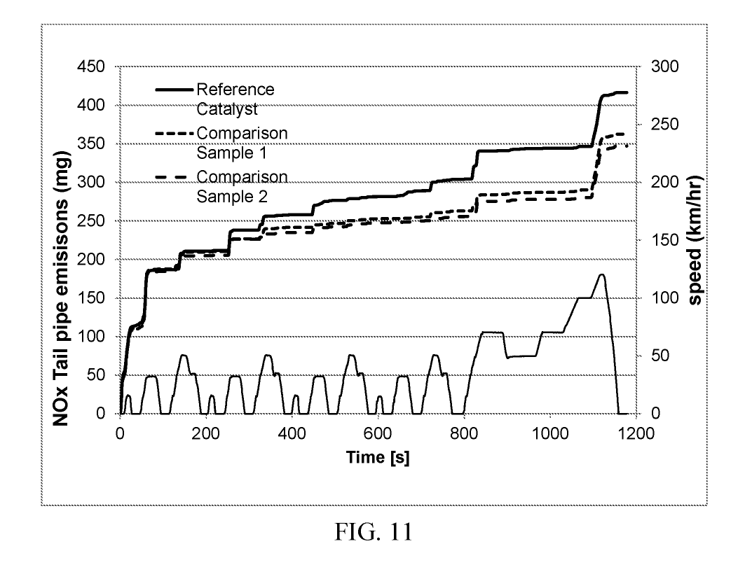

FIG. 11 shows the accumulated tail pipe NOₓ emissions of the reference catalyst sample, comparison catalyst sample 1, and comparison catalyst sample 2 under the NEDC drive cycle

The results showed similar hydrocarbon and CO emissions for catalysts formed using soluble Pd and Rh metal precursors and catalysts containing Pd—Rh nanoparticles in the top coat. But lower NOₓ emission was measured for catalysts prepared with Pd—Rh nanoparticles in the top coat. The results also indicated that similar performance was observed when Pd—Rh nanoparticles were supported on either high density or low density alumina supports.

1. A catalyst article for abatement of exhaust gas emissions from an internal combustion engine comprising:
a catalyst substrate having a plurality of channels adapted for gas flow, each channel having a wall surface; and
a catalytic coating on the surfaces or inside the pores of the wall, wherein the catalytic coating comprises:
a first washcoat comprising a platinum group metal (PGM) component and a first refractory metal oxide support; and
a second washcoat comprising a plurality of palladium-rhodium nanoparticles and a second refractory metal oxide support.

2. The catalyst article of claim 1, wherein the second washcoat is present as a top layer of the catalytic coating.

3. The catalyst article of claim 1, wherein the first washcoat is disposed directly on the catalyst substrate and the second washcoat is disposed on top of the first washcoat.

4. The catalyst article of claim 1, wherein the first washcoat and the second washcoat are present in a single layer in a zoned configuration, or are disposed directly on the catalyst substrate in a zoned configuration.

5. (canceled)

6. The catalyst article of claim 1, wherein the catalytic coating further comprises a third washcoat.

7. The catalyst article of claim 6, wherein the first and second washcoat are in a zoned configuration disposed directly on the catalyst substrate and the third washcoat is deposited on top of the first and second washcoat.

8. The catalyst article of claim 6, wherein the first washcoat is disposed directly onto the catalyst substrate and the second and third washcoat are deposited on top of the first washcoat in a zoned configuration.

9. The catalyst article of claim 1, wherein the palladium-rhodium nanoparticles have an average primary particle size of about 1 to about 20 nm.

10. (canceled)

11. The catalyst article of claim 1, wherein the palladium-rhodium nanoparticles have a weight ratio of Pd:Rh of about 1:10 to about 10:1.

12. (canceled)

13. The catalyst article of claim 1, wherein the second refractory metal oxide support is alumina.

14. The catalyst article of claim 1, wherein the first refractory metal oxide support is an oxygen storage component.

15. The catalyst article of claim 1, wherein the PGM component is palladium.

16. The catalyst article of claim 1, wherein the PGM component comprises palladium, the first refractory metal oxide support is a ceria-zirconia composite, and the second refractory metal oxide support is alumina.

17. The catalyst article of claim 1, wherein the first washcoat further comprises one or more additional components selected from the group consisting of a promoter, stabilizer, and combinations thereof.

18. A method for reducing one or more of CO, HC, and NOₓ levels in an exhaust gas emission stream from an internal combustion engine, comprising contacting the exhaust gas emission stream with a catalyst article according to claim 1.

19. An exhaust gas treatment system for reducing one or more of CO, HC, and NOₓ levels in an exhaust gas emission stream from the internal combustion engine, comprising the catalyst article of claim 1, disposed downstream from the internal combustion engine.

20. The exhaust gas treatment system of claim 19, wherein the internal combustion engine is a gasoline engine.

21. A method of making a catalyst article comprising:
coating of at least a portion of a substrate carrier with a first washcoat comprising a PGM component and a first refractory metal oxide support to give a coated single-layer substrate carrier; and
coating at least a portion of the single-layer substrate carrier with a second washcoat comprising a plurality of palladium-rhodium nanoparticles and a second refractory metal oxide support to give a catalyst article.

22. The method of claim 21, further comprising providing the first washcoat, comprising the steps of:
forming an aqueous solution of a PGM salt;
contacting the aqueous solution with the first refractory metal oxide support to form a PGM-containing first refractory metal oxide support; and
mixing the PGM-containing first refractory metal oxide support with a solvent to form the first washcoat in the form of a slurry.

23. The method of claim 21, further comprising providing the second washcoat, comprising the steps of:
forming an aqueous solution of a salt of rhodium and a salt of palladium, a reducing agent, and a surfactant;
mixing and heating the aqueous solution, thereby reducing at least a portion of the rhodium and palladium to a zero valance form by action of the reducing agent in the presence of the surfactant, forming an aqueous dispersion of palladium-rhodium nanoparticles;
preparing a second solution comprising the palladium-rhodium nanoparticles and the second refractory metal oxide support to form a catalytic material solution;
drying the catalytic material; and
mixing the dried catalytic material with a solvent to form the second washcoat in the form of a slurry.
